(19) United States
(12) Patent Application Publication
(10) Pub. No.: US 2009/0033566 A1
(43) Pub. Date: Feb. 5, 2009

(54) FOLDING TYPE MOBILE RADIO

(75) Inventors: Seiichi Nakanishi, Ishikawa (JP); Kouta Aoki, Kanagawa (JP); Yutaka Saito, Ishikawa (JP); Akiyoshi Takeuchi, Ishikawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/909,354

(22) PCT Filed: Mar. 1, 2006
(86) PCT No.: PCT/JP2006/303891

§ 371 Date: Sep. 21, 2007

(30) Foreign Application Priority Data
Mar. 30, 2005 (JP) 2005-099076

(51) Int. Cl. H01Q 1/24

(52) U.S. Cl. 343/702

(57) ABSTRACT

A folding type mobile radio that can ensure high antenna performance on a desk in addition to realizing of downsizing and slimming down is provided.

An antenna element 9 has a main part placed in a lower case 10 roughly in parallel with the cabinet width direction and is connected to a matching circuit 13 on a circuit board 11 placed in the lower case 10 by spring contact or soldering, for example. The matching circuit 13 is connected to a wireless circuit 14. A conductor element 3 is placed in an upper case 1 and is connected at one end to a ground pattern of an upper circuit board 2 and is opened at an opposite end. Particularly, the conductor element 3 has a main part placed roughly in parallel with the antenna element 9 and the connection part with the ground pattern of the upper circuit board 2 is placed on the antenna element feeding part side on the hinge part 5 side. A connection line 6 is placed in the hinge part 5 and connects the ground pattern of the upper circuit board 2 and a ground pattern of the lower circuit board 11.

### TECHNICAL FIELD

This invention relates to an internal antenna of a folding mobile radio and in particular to an internal antenna for a folding mobile telephone having high antenna performance.

### BACKGROUND ART

A folding mobile telephone generally has a mechanism that can be opened and closed with an upper cabinet and a lower cabinet joined by a hinge part and can take two states of an open state and a closed state. Thus, it has two advantages of convenience for making it possible to upsize a display screen viewed in an open use state (open state) and portable ease of allowing the mobile telephone to be made a compact shape in a closed use state (closed state).

Further, in recent years, downsizing and slimming down have been demanded for the folding mobile telephone.

Known as an antenna for a folding mobile radio in a related art is a configuration wherein power is supplied to an antenna from an upper cabinet board and a passive element is installed in a lower cabinet and directivity in the closed cabinet state is controlled as disclosed in JP-A-10-84406, for example.

Also known as an antenna for a folding mobile radio in a related art is a configuration wherein an inverted L antenna is placed at the tip of an upper cabinet and a reflecting plate is provided on the display section side and directivity is controlled as disclosed in JP-A-2004-229141, for example.

### DISCLOSURE OF THE INVENTION

### Problems to be Solved by the Invention

However, in the mobile radio in JP-A-10-84406, if a conductive element having an electricity length of about a half-wave length is placed in the cabinet, it becomes difficult to downsize the cabinet; this is a problem.

However, in the mobile radio in JP-A-2004-229141, the antenna element is placed on the upper cabinet and thus it becomes difficult to slim down the upper cabinet; this is a problem.

If an antenna element is placed on a lower cabinet, when the mobile radio is placed on a desk, directivity often is oriented in the ground direction and does not match the direction of an elevation angle of 20 to 40 degrees, the incoming wave direction from a base station, and the reception sensitivity comparatively worsens; this is a problem.

The invention is embodied considering the circumstances described above and it is therefore an object of the invention to provide a mobile radio that can ensure high antenna performance when the mobile radio is placed on a desk in addition to realizing of downsizing and slimming down.

### Means for Solving the Problems

A folding type mobile radio of the invention includes a first cabinet; a second cabinet; a hinge part for joining the first cabinet and the second cabinet for rotation; a circuit board being provided in the second cabinet; a first feeding part being connected to a wireless circuit on the circuit board and placed in a hinge end part of the circuit board; an antenna element being provided in the second cabinet and receiving power supply from the first feeding part; a conductor plate being provided in the first cabinet; and a conductor element being placed in the first cabinet and having an electricity length of roughly a quarter-wave length at operation frequency, wherein one end of the conductor element is electrically connected to a position in the proximity of the first feeding part of the conductor plate, wherein an opposite end of the conductor element is opened, wherein the conductor plate and a ground pattern of a ground potential of the circuit board are electrically connected, and wherein the connection is in the proximity of the first feeding part. According to the configuration, high antenna performance can be provided in a state in which the mobile radio is placed on a desk.

In the folding type mobile radio of the invention, the main part of the conductor element and the main part of the antenna element can be placed roughly in parallel with each other. According to the configuration, high antenna performance can be provided in a state in which the mobile radio is placed on a desk.

In the folding type mobile radio of the invention, the conductor plate and the ground pattern of the ground potential of the circuit board can be connected through a reactance element of a predetermined value. According to the configuration, high antenna performance can be provided in a state in which the mobile radio is placed on a desk.

In the folding type mobile radio of the invention, the hinge part is formed of conductive metal and comprises a first hinge part provided in the first cabinet, a second hinge part provided in the second cabinet, and a joint part for electrically connecting and rotatably supporting the first hinge part and the second hinge part, the first hinge part is electrically connected to an end part of the conductor plate on the hinge part side and the second hinge part is placed with a predetermined spacing from the ground pattern on the circuit board, the mobile radio includes a second feeding part being provided in an end part on the second hinge part side in the proximity of the first feeding part; an antenna switching circuit for selectively connecting the first feeding part or the second feeding part to the wireless circuit; and open/closed detection unit for detecting an open or closed state of the first cabinet and the second cabinet, if the first cabinet and the second cabinet are closed, the antenna switching circuit connects the first feeding part and the wireless circuit, and the second feeding part is grounded through a predetermined reactance circuit, and if the first cabinet and the second cabinet are open, the antenna switching circuit connects the second feeding part and the wireless circuit, and the first feeding part can be grounded through a predetermined reactance circuit. According to the configuration, high antenna performance can be provided in a state in which the folding type mobile radio is placed on a desk, local average SAR is low, and high antenna performance can be ensured in a free space and in a telephone conversation state.

### Advantages of the Invention

The invention is intended for providing a folding type mobile radio that can ensure high antenna performance when the folding type mobile radio is placed on a desk in addition to realizing of downsizing and slimming down.

### BRIEF DESCRIPTION OF THE DRAWINGS

FIG. 1 is a perspective view of a folding type mobile radio according to a first embodiment.

FIG. 2 is a basic configuration drawing of the folding type mobile radio according to a first embodiment; FIG. 2 (a) is a drawing viewing the folding type mobile radio from a +Z direction; FIG. 2 (b) is a drawing viewing the folding type mobile radio from a Y direction; and FIG. 2 (c) is a drawing viewing the folding type mobile radio from a −Z direction.

FIG. 3 is a drawing to show an incoming wave direction from a base station in an on-desk standby state coordinate system.

FIG. 4 is a drawing of directivity of the folding type mobile radio according to the first embodiment.

FIG. 5 is a basic configuration drawing of the folding type mobile radio according to a second embodiment; FIG. 5 (a) is a drawing viewing the folding type mobile radio from a +Z direction; FIG. 5 (b) is a drawing viewing the folding type mobile radio from a Y direction; and FIG. 5 (c) is a drawing viewing the folding type mobile radio from a −Z direction.

FIG. 6 is an antenna selection operation drawing when a cabinet according to the second embodiment is closed.

FIG. 7 is an antenna selection operation drawing when the cabinet according to the second embodiment is opened.

FIG. 8 is a positional relationship drawing between a folding type mobile radio and a human body in a telephone conversation state.

### DESCRIPTION OF REFERENCE NUMERALS

1 Uppercase
2 Upper circuit board
3 Conductor element
4 Rotation shaft
5 Hinge part
6 Connection line
7 Feeding land
8 Feeding pin
9 Antenna element
10 Lower case
11 Lower circuit board
12 Upper cover

### BEST MODE FOR CARRYING OUT THE INVENTION

Folding type mobile radios of embodiments of the invention will be discussed in detail with the accompanying drawings.

### First Embodiment

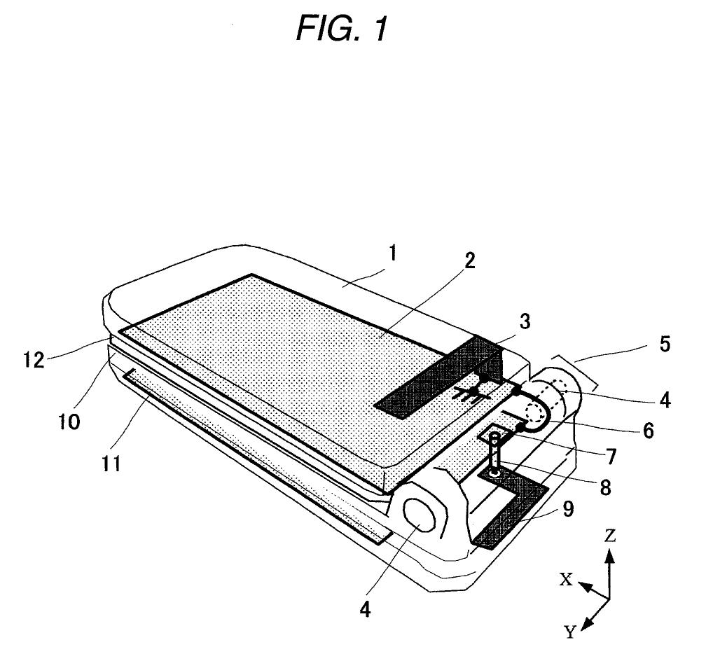

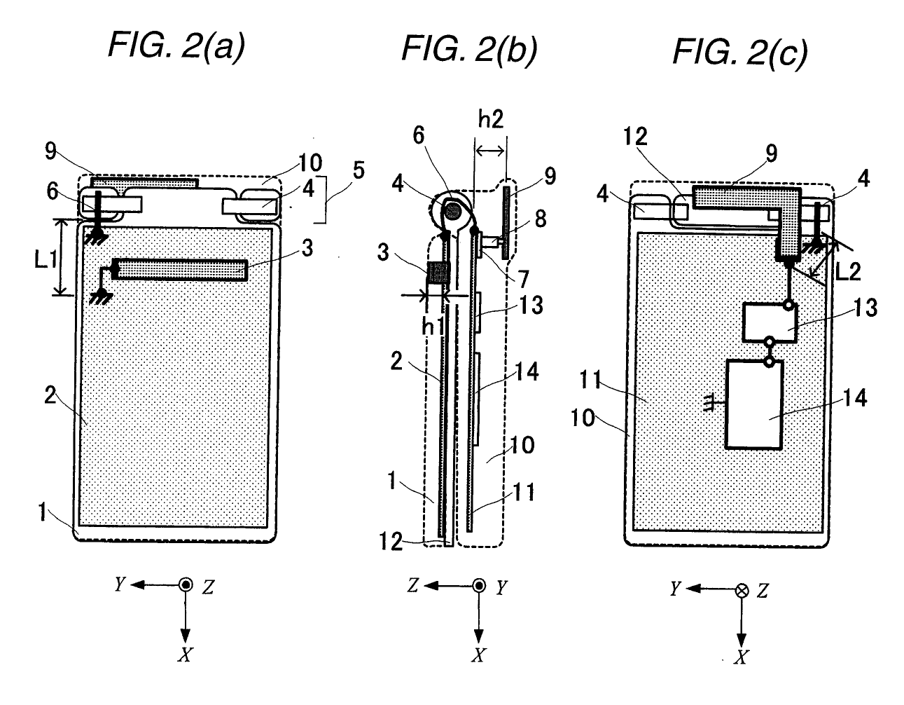

FIGS. 1 and 2 show a folding type mobile radio of a first embodiment of the invention.

In FIG. 1, a folding type mobile radio has a structure wherein an upper case 1 and a lower case 10 are joined by a hinge part 5, and as it is rotated on the hinge part 5, the folding type mobile radio can take two states of a “closed state” in which the cabinet portion is closed and an “open state” in which the cabinet portion is open. The upper case 1 and the lower case 2 are formed of resin molded articles of insulators. It is considered that the upper case 1 forms a first cabinet in the invention and the lower case 10 forms a second cabinet in the invention; it is also possible that the lower case 10 forms a first cabinet and the upper case 1 forms a second cabinet.

An upper circuit board 2 (which forms a “conductor plate”) is placed in the upper case 1, a lower circuit board 11 is placed in the lower case 10, both are printed boards on which circuit parts for implementing various functions of the mobile radio are mounted, and the printed boards are formed on almost full faces with a ground pattern as the ground potential of the circuitry.

An antenna element 9 has a main part placed in the lower case 10 roughly in parallel with the cabinet width direction and is connected to a matching circuit 13 on the circuit board 11 placed in the lower case 10 via a feeding land 7 and a feeding spring 8. In the example, the feeding land 7 and the feeding spring 8 form a first feeding section (antenna element feeding section). The matching circuit 13 is connected to a wireless circuit 14. The antenna element 9 has a length of a quarter-wave length at operation frequency (for example, about 37 mm in a 2-GHz band) and is placed roughly in parallel with the circuit board 11 with a spacing h2 (for example, about 10 mm). Particularly, the antenna element 9 is placed roughly in parallel with the cabinet width direction.

The conductor element 3 is placed in the upper case 1 and is connected at one end to the ground pattern of the upper circuit board 2 by spring contact or soldering and is opened at an opposite end. The conductor element 3 has a length of a quarter-wave length at operation frequency (for example, about 37 mm in a 2-GHz band) and is placed roughly in parallel with the upper circuit board 2 with a spacing h1 (for example, about 5 mm). Particularly, the conductor element 3 has a main part placed roughly in parallel with the antenna element 9 and the connection part with the ground pattern of the upper circuit board 2 is placed on the antenna element feeding part side on the hinge part 5 side. In other words, one end of the conductor element 3 is electrically connected to a position in the proximity of the antenna element feeding part (first feeding part) in the opposite cabinet 10 opposed to in the closed state in the upper circuit board 2.

A connection line 6 is placed in the hinge part 5 and forms an electric connection part for connecting the ground pattern of the upper circuit board 2 and the ground pattern of the lower circuit board 11. The connection line 6 is formed of a flexible board, conductor, etc., of a flexible material and is connected by spring connection or soldering so that it is not broken as the cabinet is opened and closed. Particularly, the connection point between the connection line 6 and the ground pattern of the upper circuit board 2 and the connection point between the conductor element 3 and the upper cabinet ground pattern are placed with a spacing L1 (for example, about 5 mm). The connection point between the connection line 6 and the ground pattern of the lower circuit board 11 and the feeding point of the antenna element 9 are placed with a spacing L2 (for example, about 5 mm). The length of the connection line 6 is set to L3 (for example, about 10 mm). That is, the connection line 6 connects the ground patterns of the upper circuit board 2 and the lower circuit board 11 in the proximity of the antenna element feeding part.

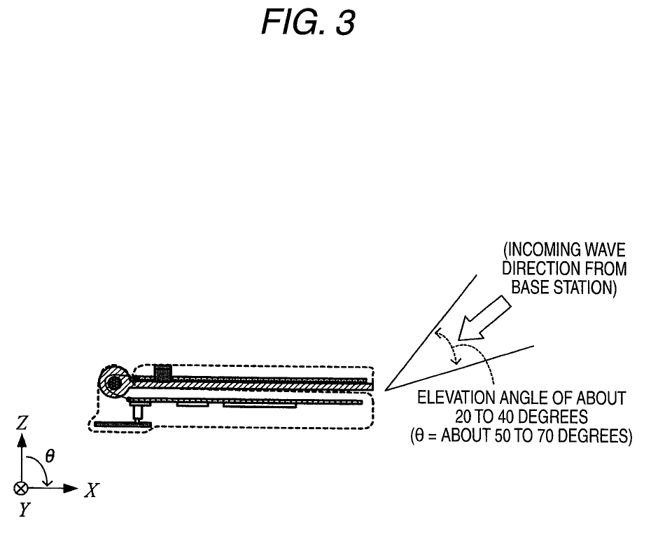

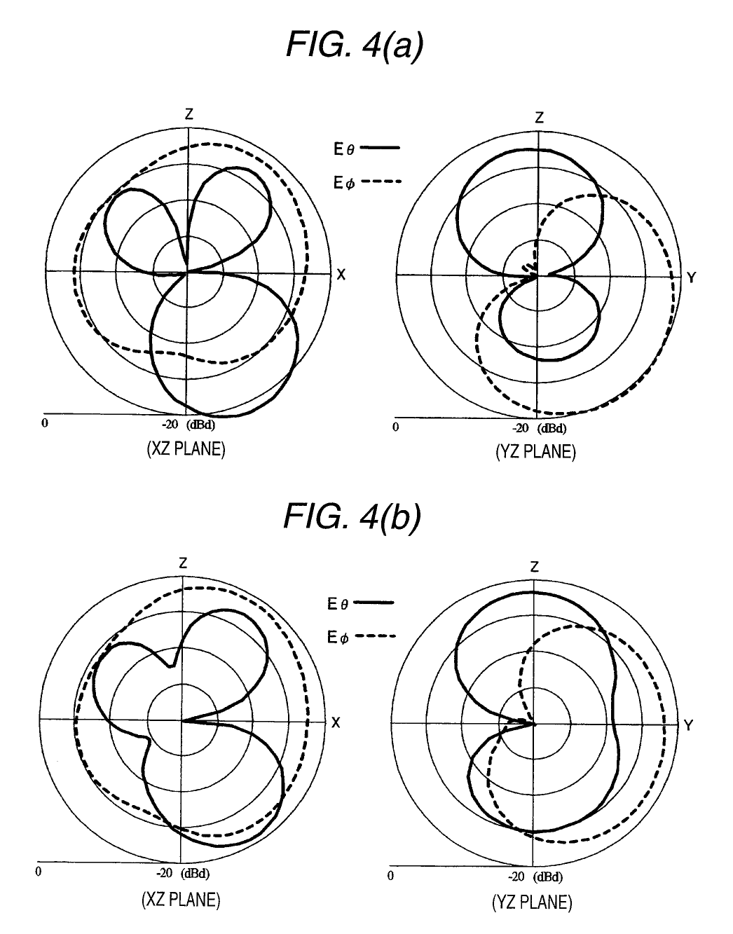

Next, the operation principle of the antenna in the embodiment will be discussed. If the folding type mobile radio in the embodiment includes neither the conductor element 3 nor the connection line 6, when the folding type mobile radio is placed on a desk in the cabinet closed state in the coordinate system in FIG. 3, the antenna element 9 is placed on the lower case 10 side and thus the directivity tends to be oriented to the −Z direction (ground direction) as shown in FIG. 4 (a) and does not match the direction of an elevation angle of 20 to 40 degrees (arrow direction in FIG. 3), the incoming wave direction from a base station, and the reception sensitivity comparatively worsens.

If the connection line 6 exists, the ground patterns of the upper circuit board 2 and the lower circuit board 11 are strongly coupled and an antenna current is distributed to the upper circuit board 2. Further, if the conductor element 3 exists, the conductor element 3 operates as a ground line and an antenna current much distributes on the conductor element 3. Since a phase difference occurs between the current on the antenna element 9 and the current on the conductor element 3, the directivity is oriented to the incoming wave direction as shown in FIG. 4 (b) and matches the direction of an elevation angle of 20 to 40 degrees (arrow direction in FIG. 3), the incoming wave direction from a base station, and the reception sensitivity improves 2 dB as compared with the case where the connection line 6 and the conductor element 3 do not exist.

In the description given above, the length of the antenna element 9 is a quarter-wave length at operation frequency, but may be a length for providing electric resonance at the operation frequency.

In FIGS. 1 and 2, the antenna element 9 is a monopole configuration, but may be an inverted L antenna or a helical antenna if the length is a length for providing electric resonance at the operation frequency.

In the description given above, the length of the conductor element 3 is a quarter-wave length at operation frequency, but may be a length for providing resonance as a ground line at the operation frequency.

In the description given above, the spacing L1 between the connection point between the connection line 6 and the ground pattern of the upper circuit board 2 and the connection point between the conductor element 3 and the upper cabinet ground pattern is set to about 5 mm, but the improvement effect of the reception sensitivity on a desk is high if the spacing is made as short as possible.

In the description given above, the spacing L2 between the connection point between the connection line 6 and the ground pattern of the lower circuit board 11 and the feeding point of the antenna element 9 is set to about 5 mm, but the improvement effect of the reception sensitivity on a desk is high if the spacing is made as short as possible.

In the description given above, the length of the connection line 6, L3, is set to about 10 mm, but the improvement effect of the reception sensitivity on a desk is high if the length is made as short as possible.

### Second Embodiment

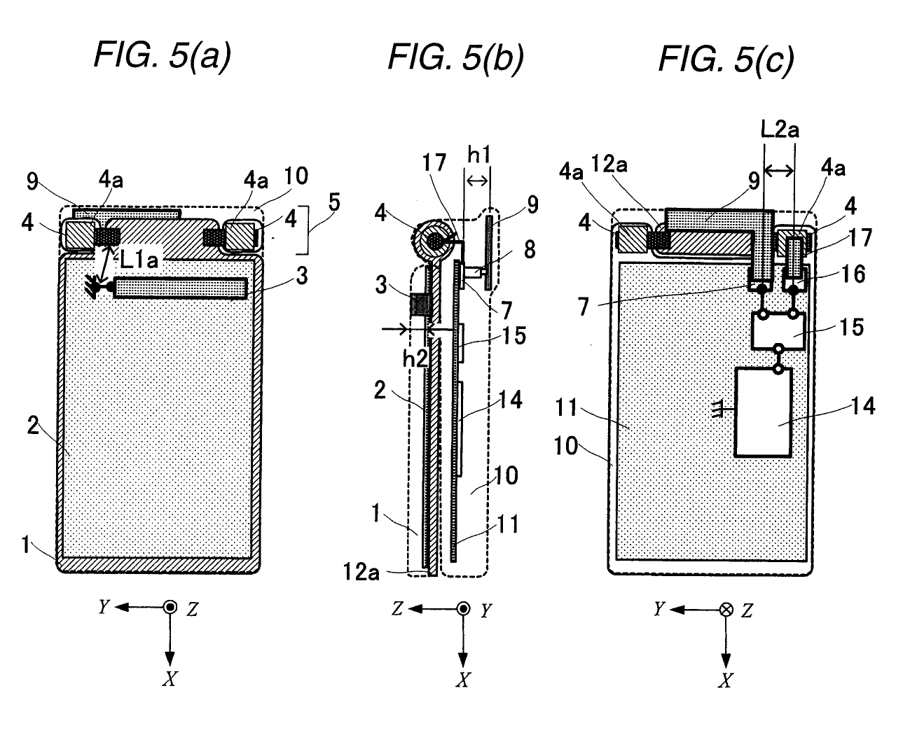

FIG. 5 shows a folding type mobile radio of a second embodiment of the invention. Components identical with those in FIG. 2 are denoted by the same reference numerals in FIG. 5 and will not be discussed again in detail.

A metal frame 12a is placed on the −Z plane of an upper case 1, namely, a plane where generally a display section is placed. Generally, the metal frame 12a uses lightweight metal having high electrical conductivity and high strength, for example, a magnesium alloy. Accordingly, the strength of the slim upper case 1 is ensured and the metal frame 12a also operates as an antennal element (which forms a “second antenna element”). Generally, the length of a long side of the metal frame 12a is about 90 mm. A ground pattern of the ground potential of an upper circuit board 2 and the metal frame 12a are fastened together by a screw, etc., for connection.

A conductor element 3 is placed in the upper case 1 and is connected at one end to the ground pattern of the upper circuit board 2 by spring contact or soldering and is opened at an opposite end. The conductor element 3 has a length of a quarter-wave length at operation frequency (for example, about 37 mm in a 2-GHz band) and is placed roughly in parallel with the upper circuit board 2 with a spacing h1 (for example, about 5 mm). Particularly, the conductor element 3 has a main part placed roughly in parallel with an antenna element 9 and the connection part with the ground pattern of the upper circuit board 2 is placed on the antenna element feeding part side on the side of a hinge part 5, and “connection point between rotation shaft 4 and metal frame 1” and “connection point between conductor element 3 and ground pattern of upper circuit board 2” described later are placed with L1 a (for example, 5 mm).

The hinge part 5 is made up of a lower end of the metal frame 12a (which forms a “first hinge part”), a hinge fitting 4a (which forms a “second hinge part”), and the rotation shaft 4. The metal frame 12a, the hinge fitting 4a, and the rotation shaft 4 are formed of conductive metal and are configured so as to electrically conduct at their respective contact points. The metal frame 12a, the hinge fitting 4a, and the rotation shaft 4 make up an electric connection part for electrically connecting ground patterns of the upper circuit board 2 and a lower circuit board 11 through a second feeding part described later. The lower end of the metal frame 12a and the hinge fitting 4a are rotatably joined by the rotation shaft 4 corresponding to joint unit.

The antenna element 9 (which forms a “first antenna element”) is installed in a lower case 10 to the hinge part 5. The antenna element 9 has a feeding land 7 provided at one end and connected to an antenna control circuit section 15 through a feeding spring 8 and is opened at an opposite end.

The hinge fitting 4a is connected at one end (the right in FIG. 5) to the antenna control circuit section 15 through a feeding land 16 and a feeding spring 17. The feeding land 16 and the feeding spring 17 make up a second feeding section.

The feeding land 7 and the feeding land 16 are placed at a predetermined distance L2a (for example, about 5 mm).

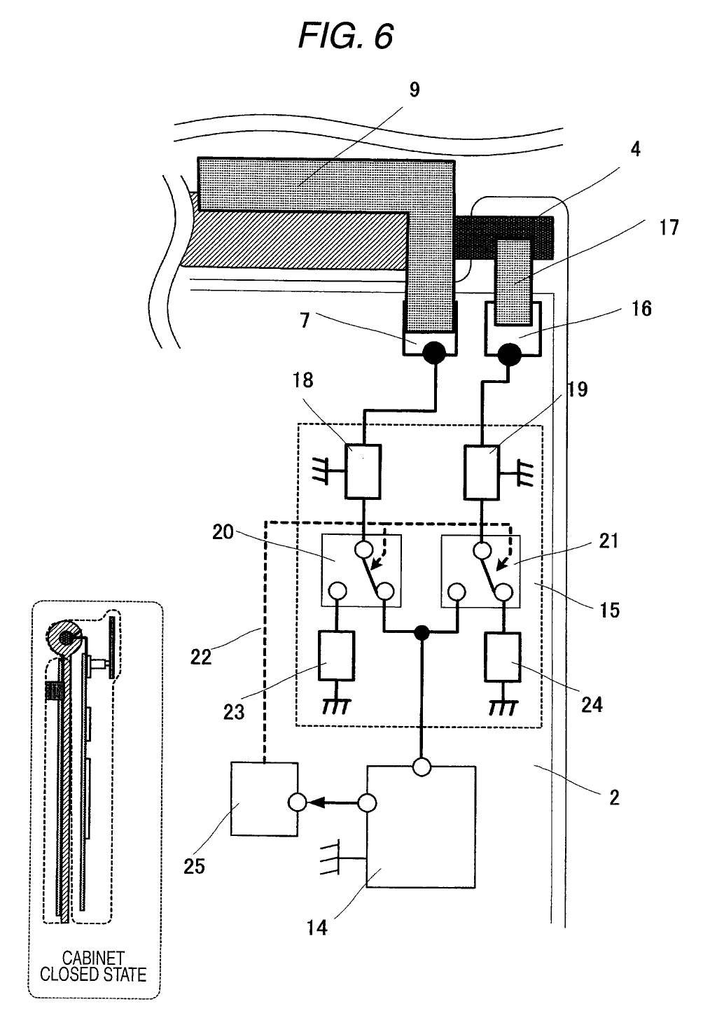

The above-mentioned antenna control circuit section 15 provided in the lower case 10 is made up of a matching circuit 18, a matching circuit 19, a high-frequency switch 20, a high-frequency switch 21, a terminal reactance element 23, and a terminal reactance element 24, as shown in FIG. 6.

A wireless circuit section 14 and an open-closed detector 25 are connected to the above-mentioned antenna control circuit section 15. The open-closed detector 25 is implemented as a hole element, etc., for example, and as the open-closed detector 25 and the antenna control circuit section 15 are ganged together, connection between the wireless circuit section and the antenna element can be switched in response to opening/closing of the cabinet.

Next, the functions in (I) closed state and (II) open state of the upper case 1 and the lower case 10 of the cabinet of the folding type mobile radio according to the embodiment will be discussed.

(I) FIG. 6 shows a state in which the wireless circuit section 14 selects 12 the antenna element 9 and the hinge fitting 4a is connected to the terminal reactance element 24 in the “closed state” of closing the upper case 1 and the lower case 10 of the folding type mobile radio. The hinge fitting 4a is connected to the metal frame 12a through the hinge part 5.

At this time, the antenna element 9 is connected to the wireless circuit section 14 through the high-frequency switch 20, the matching circuit 19, the feeding land 7, and the feeding spring 8 and receives power supply as an antenna.

The hinge fitting 4a is grounded to a ground pattern of the ground 10 potential of the lower circuit board 11 through a feeding spring 17, a feeding land 16, the matching circuit 19, the high-frequency switch 21, and the terminal reactance element 24. At this time, the value of the terminal reactance element 24 is adjusted and the impedance viewing the matching circuit 19 from the hinge fitting 4a side is lowered, namely, the metal frame 12a and the ground 15 pattern of the lower circuit board 11 are connected and the upper circuit board 2 and the lower circuit board 11 are “strongly coupled” like high frequency.

Thus, functions similar to those of the first embodiment can be provided in the cabinet closed state, and the reception sensitivity on a desk is improved about 2 dB as compared with the case where the conductor element 3 and the feeding spring 17 do not exist.

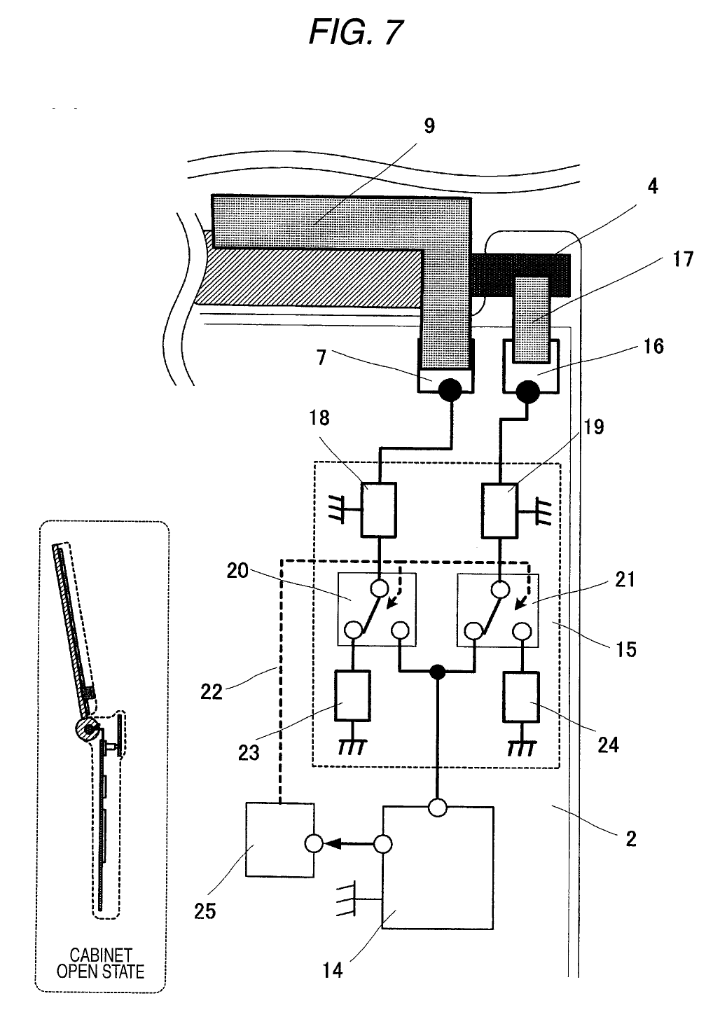

(II) FIG. 7 shows a state in which the wireless circuit section 14 selects the hinge fitting 4a and the antenna element 9 is connected to the terminal reactance element 23 in the “open state” of opening the upper case 1 and the lower case 1 of the folding type mobile radio. The hinge fitting 4a is connected to the metal frame 12a through the hinge part 5.

At this time, the metal frame 12a (which forms a “second antenna element”) is connected to the wireless circuit section 14 through the hinge fitting 4a, the feeding spring 17, the feeding land 16, the matching circuit 19, and the high-frequency switch 21 and receives power supply as an antenna and the whole cabinet operates as a dipole antenna. Since the whole cabinet operates as an antenna, the electric volume of the antenna is high, so that the antenna performance of a wide-band, high antenna efficiency characteristic can be provided.

The antenna element 9 is connected through the feeding spring 8, the feeding land 7, the matching circuit 18, the high-frequency switch 20, and the terminal reactance element 23. At this time, the value of the terminal reactance element 23 is adjusted and the impedance viewing the matching circuit 18 from the antenna element 9 is lowered, namely, the antenna element 9 and the ground pattern of the lower circuit board 11 are connected for operating as a ground line.

The conductor element 3 operates as a ground line connected to the ground pattern of the upper circuit board 2.

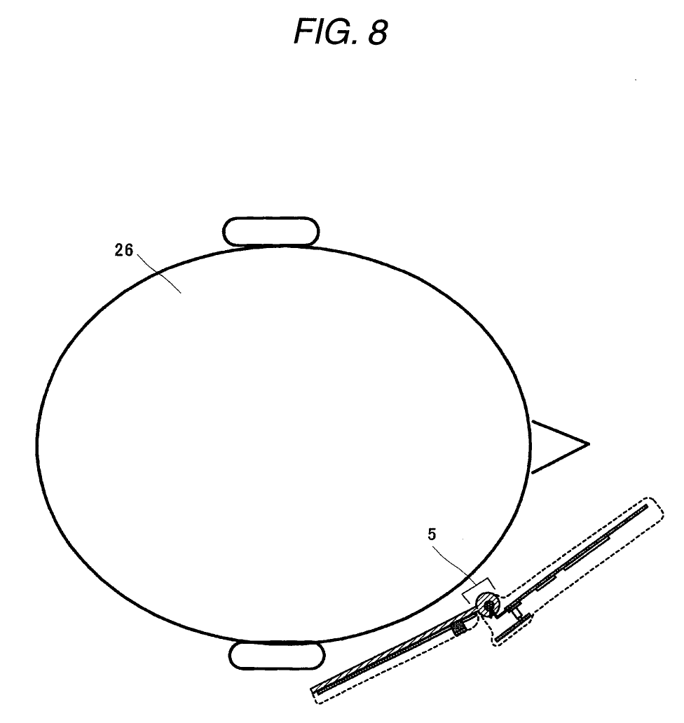

Generally, as shown in FIG. 8, in a “telephone conversation state” in which the user holds a telephone conversation with a mobile radio in the proximity of the head of the human body, if the antenna element and the human body approach each other, local average SAR (Specific Absorption Rate) becomes comparatively high. Also in the mobile radio of the embodiment, if the conductor element 3 and the antenna element 9 do not exist, antenna current concentrates on the hinge part 5 in the vicinity of the feeding part and the SAR becomes comparatively high.

If the conductor element 3 and the antenna element 9 exist, each element operates as a ground line, the antenna current concentrates on the conductor element 3 and the antenna element 9 at a distance from a human body 26, the human body 26 and the antenna current can be brought away from each other, and the SAR can be decreased about 30%.

As described above, the radio of the embodiment can ensure high antenna performance on a desk in the closed state and can ensure low SAR and high antenna performance in the open state.

In the description given above, the length of the antenna element 9 is a quarter-wave length at operation frequency, but may be a length for providing electric resonance at the operation frequency.

In FIGS. 5, 6, and 7, the antenna element 9 is a monopole configuration, but may be an inverted L antenna or a helical antenna if the length is a length for providing electric resonance at the operation frequency.

In the description given above, the length of the conductor element 3 is a quarter-wave length at operation frequency, but may be a length for providing resonance as a ground line at the operation frequency.

In the description given above, the distance L1a between the “connection point between the rotation shaft 4 and the metal frame 1” and the “connection point between the conductor element 3 and the ground pattern of the upper circuit board 2” is set to 5 mm, but the improvement effect of the reception sensitivity on a desk is high if the distance is made as short as possible.

In the description given above, the spacing L2a between the feeding land 7 and the feeding land 16 is set to about 5 mm, but the improvement effect of the reception sensitivity on a desk is high if the spacing is made as short as possible.

While the embodiments of the invention have been described, it is to be understood that the invention is not limited to the items disclosed in the embodiments and the invention also intends that those skilled in the art make changes, modifications, and application based on the Description and widely known arts, and the changes, the modifications, and the application are also contained in the scope to be protected.

This application is based on Japanese Patent Application (No. 2005-099076) filed on Mar. 30, 2005, which is incorporated herein by reference.

### INDUSTRIAL APPLICABILITY

As described above, the invention is useful for providing high wireless communication performance of a folding type mobile radio because high antenna performance on a desk can be ensured in addition to realizing of downsizing and slimming down.

1-10. (canceled)

11. A mobile radio comprising:
a first cabinet;
a second cabinet;
a hinge part, joining said first cabinet and said second cabinet for rotation;
a circuit board, provided in said second cabinet;
a first feeding part, connected to a wireless circuit on said circuit board and placed in a hinge end part of said circuit board;
an antenna element, provided in said second cabinet and receiving power supply from said first feeding part;
a conductor plate, provided in said first cabinet; and
a conductor element, placed in said first cabinet and having an electricity length of roughly a quarter-wave length at operation frequency, wherein one end of said conductor element is electrically connected to a position in the proximity of said first feeding part of said conductor plate, an opposite end of said conductor element is opened, and
said mobile radio comprises an electric connection part for electrically connecting said conductor plate and a ground pattern of a ground potential of said circuit board in the proximity of said first feeding part.

12. The mobile radio as claimed in claim 11 wherein the main part of said conductor element and the main part of said antenna element are placed roughly in parallel with each other.

13. The mobile radio as claimed in claim 11, wherein said conductor plate and the ground pattern of the ground potential of said circuit board are connected through a reactance element of a predetermined value.

14. The mobile radio as claimed in claim 11, wherein:
said hinge part is formed of conductive metal and comprises a first hinge part provided in said first cabinet, a second hinge part provided in said second cabinet, and a joint part for electrically connecting and rotatably supporting the first hinge part and the second hinge part;
the first hinge part is electrically connected to an end part of said conductor plate on the hinge part side and the second hinge part is placed with a predetermined spacing from the ground pattern on said circuit board; said mobile radio comprises:
a second feeding part being provided in an end part on the second hinge part side in the proximity of said first feeding part;
an antenna switching circuit for selectively connecting said first feeding part or the second feeding part to the wireless circuit; and
an open/closed detection unit for detecting an open or closed state of said first cabinet and said second cabinet,
if said first cabinet and said second cabinet are closed, the antenna switching circuit connects said first feeding part and the wireless circuit, and the second feeding part is connected to the ground pattern on said circuit board through a predetermined reactance circuit, and
if said first cabinet and said second cabinet are open, the antenna switching circuit connects the second feeding part and the wireless circuit, and said first feeding part is connected to the ground pattern on said circuit board through a predetermined reactance circuit.

15. A mobile radio comprising:
a first cabinet;
a second cabinet;
a hinge part for joining said first cabinet and said second cabinet for rotation;
a circuit board being provided in said second cabinet;
a first feeding part being connected to a wireless circuit on said circuit board;
a first antenna element being provided in said second cabinet and receiving power supply from said first feeding part;
a conductor plate being provided in said first cabinet;
a conductor element having a first end electrically connected to said conductor plate and a second end opened in said first cabinet; and
an electric connection part for electrically connecting said conductor plate and a ground pattern of a ground potential of said circuit board.

16. The mobile radio as claimed in claim 15 wherein the main part of said conductor element and the main part of said antenna element are placed roughly in parallel with each other.

17. The mobile radio as claimed in claim 15, wherein said conductor plate and the ground pattern of the ground potential of said circuit board are connected through a reactance element of a predetermined value.

18. The mobile radio as claimed in claim 15, wherein said electric connection part is implemented as a connection line placed in said hinge part.

19. The mobile radio as claimed in claim 15, wherein said first cabinet further comprises a metal fame electrically connected to said conductor plate;
said hinge part is made up of a hinge fitting, a rotation shaft, and one end part of the metal frame; and
said electric connection part is made up of the hinge fitting, the rotation shaft, and the metal frame.

20. The mobile radio as claimed in claim 15, wherein said hinge part is formed of conductive metal and comprises a first hinge part provided in said first cabinet, a second hinge part provided in said second cabinet, and a joint part for electrically connecting and rotatably supporting the first hinge part and the second hinge part;
the first hinge part is electrically connected to an end part of said conductor plate on the hinge part side and the second hinge part is placed with a predetermined spacing from the ground pattern on said circuit board;
said mobile radio comprises:
a second feeding part being provided in an end part on the second hinge part side in the proximity of said first feeding part;
an antenna switching circuit for selectively connecting said first feeding part or the second feeding part to the wireless circuit; and
an open/closed detection unit for detecting an open or closed state of said first cabinet and said second cabinet;
if said first cabinet and said second cabinet are closed, the antenna switching circuit connects said first feeding part and the wireless circuit, and the second feeding part is connected to the ground pattern on said circuit board through a predetermined reactance circuit; and
if said first cabinet and said second cabinet are open, the antenna switching circuit connects the second feeding part and the wireless circuit, and said first feeding part is connected to the ground pattern on said circuit board through a predetermined reactance circuit.
